(19) United States
(12) Patent Application Publication
(10) Pub. No.: US 2025/0168258 A1
(43) Pub. Date: May 22, 2025

(54) DATA TRANSMISSION FOR IoT DEVICES

(71) Applicant: VODAFONE IP LICENSING LIMITED, Newbury, Berkshire (GB)

(72) Inventor: Timothy Paul EVANS, Newbury, Berkshire (GB)

(21) Appl. No.: 18/840,435

(22) PCT Filed: Feb. 27, 2023
(86) PCT No.: PCT/GB2023/050431

§ 371 Date: Aug. 21, 2024

(30) Foreign Application Priority Data
Feb. 28, 2022 (GB) 2202734.6

(51) Int. Cl. H04L 69/164; H04L 67/12

(52) U.S. Cl. CPC H04L 69/164; H04L 67/12

(57) ABSTRACT

A method and system for communication of data between a client and a server over a telecommunication network. The method comprises encoding the data using tag-length-value (TLV) encoding scheme, and sending the encoded data via User Datagram Protocol (UDP).

### FIELD OF THE INVENTION

A method and system for data transmission between a client and a server, especially where the client is a narrow band (NB) Internet of Things (IoT) device and/or the client communicates with the telecommunications network using NB-IoT technology. The described method and system provides secure data transmission and low power usage at the client.

### BACKGROUND TO THE INVENTION

The Internet of Things (IoT) describes objects in which are typically embedded, one or more of sensors, actuators and other technology having the ability to connect and exchange data with servers and other devices over communications networks (such as the Internet). Typically, the devices (for example, sensors or actuators) embedded within IoT objects will send and receive small amounts of data (for instance, sensor measurements, or configuration updates) as regular but infrequent transmissions. Such devices may be installed in objects which may be relatively physically inaccessible, and which may rely on a battery power source that cannot be changed or recharged frequently (a resource constrained device). As such, there is a desire for devices within many IoT objects to operate with reduced power and limited processing and storage capabilities.

Narrow Band-Internet of Things (NB-IoT) describes low power wide area network technology described in industry standards (for example, those set by the Third Generation Partnership Project, 3GPP) and developed to enable a wide range of new IoT devices and services. NB-IoT significantly improves the power consumption of user devices, system capacity and spectrum efficiency.

Various protocols can be employed for communication at the transport layer between a client at a NB-IoT device and a server. One example of such a protocol is User Datagram Protocol (UDP). UDP has no handshaking requirements, and may allow for lightweight communications. UDP, being a connectionless protocol that does not set up or rely upon an existing connection with a destination prior to transmission of data, prioritises the quick transmission of data over reliability and accuracy of data transmission. As such, UDP can be used for purposes where error checking and a stable connection are not necessary or performed (such as time-sensitive applications). However, this means that UDP does not commonly provide any mechanism for error correction or identification of undelivered data packets. Moreover, UDP typically does not provide for transmission using secure application protocols (such as HTTPS).

In view of the above, there is required an improved method and system for secure data transmission between clients at IoT objects and a server.

### SUMMARY OF THE DISCLOSURE

The present invention aims to improve on the shortcomings of the prior art. The proposed solution looks to provide a method for communication of data between a client and a server over a telecommunication network that may be made secure but also transmits only small data packets infrequently. Such a solution, which sends as little data as possible, allows for low power usage at client devices (such as NB IoT devices), and so a long battery life before replacement and recharging.

The solution makes use of User Datagram Protocol (UDP) for transmission of data between the client and server at the transport layer. At the user plane of the application layer, the data is encoded as a tag-length-value (TLV, sometimes known as type-length-value). Specific parameters and TLV structure may be used for communication of information relating to a measurement or a characteristic of a device (which may be a sensor, for instance). In communications from a client to a server, the TLV encoded data may be measurement parameters. In communications from a server to a client, for instance subsequent to receipt of a data packet from the client, the data may include a TLV-encoded acknowledgement. To provide additional security, the TLV encoded data may be embedded in a user plane message under End to Middle Secured Data Protocol (EMSDP) as prescribed by Security Procedures for Battery Efficient Security for Very Low Throughput MTC Devices (BEST, described at 3GPP TS 33.163). In this way, the described solution, which could be considered a TLV based protocol in the application layer, provides very lightweight communication between client and server.

As a consequence the proposed method is particularly suited to environments and applications where power resources are limited, for instance when communicating data to and from low-power sensing devices or actuator devices. Such devices may be positioned in remote locations to measure sensor readings and then may not be easily physically accessible for maintenance. These devices may be fitted with a battery on manufacture, which is not charged or replaced throughout the life of the device (or is charged and/or replaced very infrequently, at least in the order of years). Moreover, the devices may comprise limited processing resources, and limited memory or logical storage.

In a first aspect, there is described a method for communication of data between a client and a server over a telecommunication network, comprising: encoding the data using tag-length-value (TLV) encoding scheme; and, sending the encoded data via User Datagram Protocol (UDP). The communication may be towards the client from the server, or from the server towards the client, and the telecommunication network may be a cellular network. It will be understood that the method does not depend on the delivery of the communication, and describes the method of sending.

The TLV-encoded data may be included in a data field at the user plane of the application layer, and embedded within UDP for transmission. The TLV-encoded data is compact, and may reduce the size of the data to be transmitted to only a few bytes (for instance in most cases, a measurement and identifier for a sensor can be transmitted in around 4 bytes, for instance). The TLV encoding allows the data to be of fixed or variable length. In combination with UDP, which is a connectionless (“fire-and-forget”) protocol, the described method of data communication is lightweight and requires only very low power consumption. Therefore, client devices having a low power source (for example, a device drawing a current of no more or less than 2 μA from a battery when in standby mode) can periodically send information to a server whilst maintaining a long battery life.

The client is advantageously a narrow band Internet of Things (NB-IoT) device, and/or the client communicates with the telecommunications network using NB-IoT technology. For instance, the client may be a NB-IoT device such as a sensor or actuator. In another example, the client may communicate with a server using NB-IoT technology being a set of standards-based low power wide area (LPWA) technologies, comprising both radio area network (RAN) and core network technologies.

The NB-IoT device may comprise or may be connected to one or more sensors and/or actuators. For instance, the sensors may be low-power sensing devices, for measurement of specific parameters in the environment surrounding the device or for measurement of its position. Examples include accelerometers, humidity sensors, tilt sensors, movement sensors, and GNSS (Global Navigation Satellite System) sensors. Additionally or alternatively, NB-IoT devices could comprise or connected to actuators, for instance to control valves within environment regulation or irrigation systems. It will be understood that the client could be any form of IoT device from which (typically simple) measurements or readings are obtained.

Sending the encoded data via UDP may comprise sending the encoded data in the user plane in a data field of a user plane message. For instance, the user plane message may be a user plane End to Middle Secured Data Protocol (EMSDP) message, as prescribed by Security Procedures for Battery Efficient Security for Very Low Throughput MTC Devices (BEST) and described at 3GPP TS 33.163. The header portion of the user plane message and the control plane message of EMSDP using BEST may also make use of TLV. However, it is the use of TLV encoded data in the data field of the user plane message that provides the particular benefits of the present solution.

The sending may use Battery Efficient Security for Very Low Throughput MTC Devices (BEST). BEST may be implemented at the application layer. BEST gives a secure channel between a client and server, optimised for low throughput and high latency devices that are battery constrained. The user plane for BEST is provided by the application layer between the client and server, and offers a confidentiality protected user plane service for low throughput devices. Use of BEST is advantageous where the control of IoT devices (for instance, sensors and/or actuators), or the access to measurements or reading by IoT devices (for example, sensors) should be restricted to authorised users.

The data to be sent from the client to the server may comprise a measurement from a sensor (encoded as a TLV). Optionally, the data to be sent from the client to the server comprises a transport header TLV and a data list TLV. In particular, the TLV encoded data may have a specific and prescribed format. For instance, in communications from the client to the server the data field in the user message plane may include a TLV encoded header (including information such as a number of TLVs being sent and a transaction identity) and a TLV data list (including the measured value of one or more parameters of a sensor, or measured values at one or more sensors connected to the IoT device).

The data to be sent from the server to the client may comprise configuration or control data. For instance, the data may be used at the client device to reconfigure operation parameters or to operate an aspect of the device (for example, to move an actuator, or to open or close a value).

The data to be sent from the server to the client may comprise an acknowledgment. Typically UDP is a connectionless protocol, and acknowledgement is only provided at the application layer. The presently described method incorporates an acknowledgement as TLV-encoded data within the data field of the user plane message. Upon receipt of data at a server from the client, a communication (for instance including the acknowledgment) is be sent from the server to the client promptly before the non-persistent connection between the client and server under UDP is closed.

The data sent from the server to the device may comprise a transport header TLV and an acknowledgement TLV and may further comprise a configuration TLV. As noted above, the TLV encoded data may have a specific and prescribed format. For instance, in communications from the server to the client the data field in the user message plane may include at TLV header (comprising information on the number of TLVs being transferred and the transaction identity). The TLV header may be immediately followed by an acknowledgement TLV (comprising a numerically coded message related to the delivery status of the immediate proceeding package).

Data may be sent from the server to the device after receipt of data sent from the device to the server. UDP does not provide a persistent connection between client and server (typically an IP address is temporarily allocated for less than a few seconds). Therefore, any return data must be sent promptly before closure of a connection over which an initial data packet was sent (for instance, a return packet ideally should be sent within 1-900 ms).

TLVs may be employed in the present method as application layer encoding. The method could be considered as offering a TLV based protocol at the application layer.

In a second aspect, there is described a client for communication of data to and/or from a server over a telecommunication network, configured to: send or receive, via User Datagram Protocol (UDP), data encoded using tag-length-value (TLV) encoding scheme. For instance, the client may be configured to encode the data using tag-length-value (TLV) encoding scheme, and send the encoded data via User Datagram Protocol (UDP). The client may have a transmitter and receiver, a processor and preferably memory (logical storage means). The processor may be configured to perform the encode and send step (in other words, the processor may be configured to perform the client-based steps of the method described above). The telecommunication network may be a cellular network. The encoded data may be sent in a user plane of the application layer embedded in UDP.

The client may be configured to: encode data using the TLV encoding scheme; and/or decode data encoded using the TLV encoding scheme. In other words, the client may prepare TLV-encoded data for sending via UDP, or may receive TLV-encoded data via UDP and subsequently decode the data.

For instance, the client may be configured to: receive, via UDP, further data encoded using the TLV encoding scheme; and, decode the further data. Once decoded, the client may implement commands included within the further data (for instance, via a processor at the client). In one example, the further data includes a control command for a client being an actuator.

The client may be a narrow band Internet of Things (NB-IoT) device, and/or the client may communicate with the telecommunications network using NB-IoT technology (for instance, comprising RAN and core network technologies).

The NB-IoT device may comprise or may be connected to one or more sensors and/or actuators. For instance the client device may include a number of low-power sensors or actuators, or may receive measurements from similar devices.

Sending the encoded data via UDP may comprise sending the encoded data in the user plane in a data field of a user plane message. The user plane message may be a user plane End to Middle Secured Data Protocol (EMSDP) message according to the Security Procedures for Battery Efficient Security for Very Low Throughput MTC Devices (BEST) according to 3GPP TS 33.163, version 15.4.0, release 15. Optionally, the sending uses Security Procedures for Battery Efficient Security for Very Low Throughput MTC Devices (BEST).

The data to be sent from the client to the server may comprise a measurement from the sensor. Preferably, the data to be sent from the client to the server comprises a transport header TLV and a data list TLV.

The data to be received at the client from the server may comprise configuration or control data. The data to be received at the client from the server may further comprise an acknowledgment. Optionally, the data sent from the server to the device, comprises a transport header TLV and an acknowledgement TLV and may further comprise a configuration TLV. Options for the format of each type of TLV are described in more detail below.

In a third aspect, there is described a server for communication of data from and/or to a client over a telecommunication network, configured to: send or receive, via User Datagram Protocol (UDP), data encoded using tag-length-value (TLV) encoding scheme. In one example, the server may be configured to: receive, via UDP, data encoded using the TLV encoding scheme; and, store the received data. The server may comprise a receiver (receiving means), a transmitter (transmitting means), memory (storage means) and a processor. The processor may be configured to perform the server-based steps of the method described above.

Ideally, the server is configured to store received data. In an example, data received at the server may be saved in a raw format at a database in the memory, without decoding of the data immediately upon receipt. This it to keep the UDP port at the server open and listening, to allow receipt of any transmissions from the same or other clients. By the nature of UDP, any data packets will not be queued at the UDP port of the server, and so if not received due to temporary unavailability of the port the data packet would instead be lost.

The server may be further configured to: decode received data encoded using the TLV encoding scheme; and, store the decoded data. In other words, the TLV encoded data will be decoded at the server to provide interpreted (more easily readable) data. Such interpreted data may be stored at a database at the memory of the server, and made available to users as required. In some examples, the data is made available through a web portal or application programming interface (API).

The server may be further configured to: encode data using the TLV encoding scheme, the encoded data for sending from the server via UDP. For instance, the server may encode and send TLV-encoded data to the client upon receipt of a data packet from the client. The data sent from the server may include an acknowledgement of receipt and/or configuration or command data for the device at the client.

The server may be further configured to transmit the received data and/or the decoded data to a user portal, to external memory and/or to a Representational State Transfer (REST) application programming interface (API). For example, the server may be configured to make already decoded, interpreted data received from the client available to users via the internet, or to store the interpreted data (or raw data) externally.

In a fourth aspect, there is described a system for communication of data from and/or to a client over a telecommunication network comprising the client as described above and the server as described above. Optionally, the system further comprises one or more sensors and/or actuators connected to the client. Optionally, the system further comprises one or more web portal or API connected to the server.

In a fifth aspect, there is described a computer program that, when executed on a computer processor, causes the client to operate as described above. In other words, the computer program may be configured to cause the client to carry out the client-based steps of the above described method. The computer program may be stored at computer memory at the client device, to be executed on a processor at the client device.

In a sixth aspect, there is described a computer program that, when executed on a computer processor, causes the server to operate as described above. In other words, the computer program may be configured to cause the server to carry out the server-based steps of the above described method. The computer program may be stored at computer memory at the server, to be executed on a processor at the server.

Characteristics of features in the method described may apply equally to the corresponding features of the client, server or system.

### BRIEF DESCRIPTION OF THE FIGURES

The disclosure can be put into practice in a number of ways, and preferred embodiments will now be described by way of example only and with reference to the accompanying drawings, in which:

FIG. 1 is a block diagram of a system for implementing a method for communication of data between a client and a server over a telecommunication network;

FIG. 2 is a schematic representation of the Internet protocol suite;

FIG. 3 is a schematic representation of the TLV encoded data embedded in application data; and

FIG. 4 is a block diagram of a system for implementing a method for communication of data between a client and a server over a telecommunication network, and more particularly the server.

In the figures, like parts are denoted by like reference numerals. The figures are not drawn to scale.

### DETAILED DESCRIPTION OF THE SPECIFIC EMBODIMENTS OF THE INVENTION

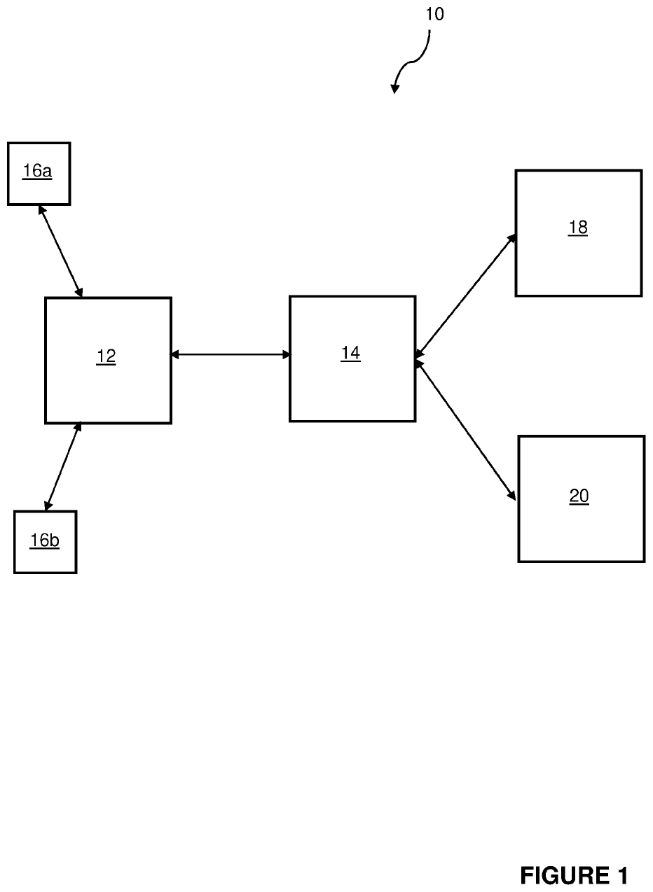

FIG. 1 shows a system architecture for implementing a method for communication of data between a client and a server over a telecommunication network. The system may be described as a Universal Prototyper. The telecommunication network may be a cellular network. In particular, the system 10 includes a client 12 and a server 14. The system may be especially beneficial for use where the client is a narrow band Internet of Things (NB-IoT) device, and/or the client communicates with the telecommunications network (and server) using NB-IoT technology. NB-IoT technology may comprise Radio Area Network (RAN) technology and/or core network technology.

In the example of FIG. 1, the client is an NB-IoT device comprising or connected to a sensor 16a and an actuator 16b. The client receives data (such as measurements or configuration data) from the sensor 16a and/or actuator 16b. The client may also pass data (including data requests or reconfiguration instructions) to the sensor 16a and/or actuator 16b. In an example, data is passed between the client and the sensor and/or actuator via an I²C serial communications bus (see, for example, https://en.wikipedia.org/wiki/I%C2%B2C, accessed 24 Feb. 2022).

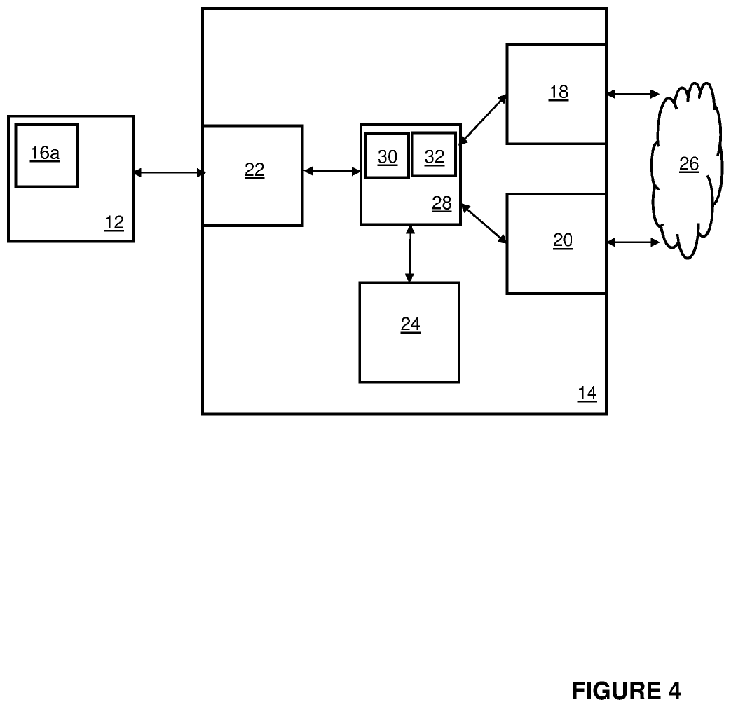

The system further comprises elements in communication with the server. In the example of FIG. 1, a web portal 18 is provided for a user to connect to the server over the internet, for instance for retrieval of data obtained from the sensor 16a via the client 12 and subsequently stored at the server 14. FIG. 1 also shows a Representational State Transfer (REST) Application Programming Interface (API) 20 for access by users of data stored at the server 14. The server is discussed in more detail below with respect to FIG. 4.

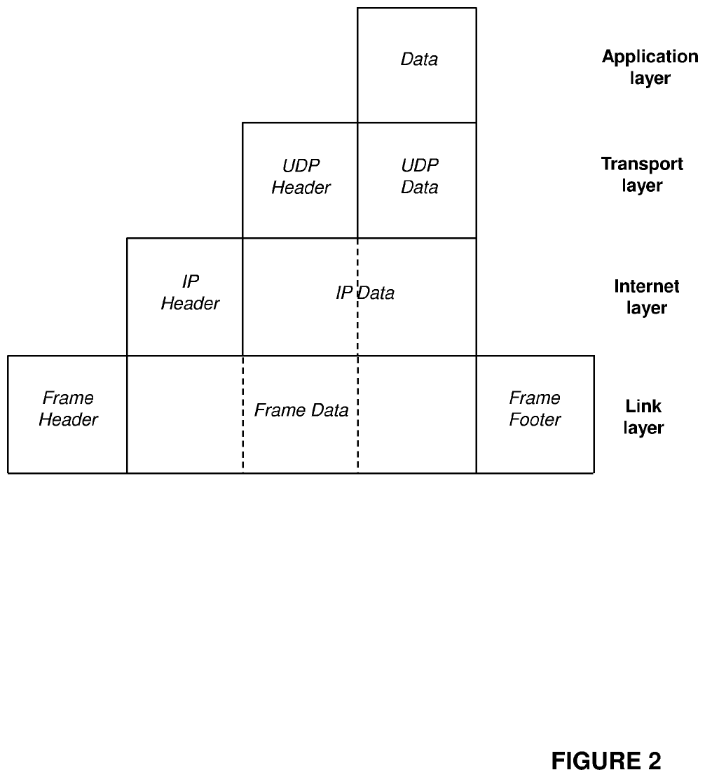

Of particular interest is the method for communication of data between the client 12 and server 14. FIG. 2 shows the four layer model familiar under the Internet Protocol Suite (TCP/IP), which represents a set of communication protocols used in Internet or network communications. As noted above, communications relating to IoT devices (and specifically NB-IoT devices) can beneficially make use of User Datagram Protocol (UDP) in the transport layer. Use of UDP may be preferential to Transmission Control Protocol (TCP) for communication of infrequent and/or low power transmission of data as found at a sensor or actuator in an IoT device, not least because UDP does not establish a sustained connection between client and server, and does not wait for packets delayed due to retransmission (as would be the case in TCP). Typically, communications with NB-IoT devices are constrained to use of UDP instead of TCP. However, UDP does not generally provide for transmission using secure application protocols (such as HTTPS), nor provide any mechanism for acknowledging receipt of data packets.

The present inventors have identified a method for communication that maintains a number of the benefits of UDP at the transport layer, whilst providing secure and compact data transmission. This results from incorporation of a Tag-Length-Value-based (TLV-based) protocol at the application layer, as described below.

Referring to FIG. 2, it can be seen that UDP data embeds application layer data. In the presently described example method, the application data comprises a user plane message in which the data portion of the user plane message is encoded in TLV. TLV is an encoding scheme used for optional informational elements in a certain protocol. A TLV-encoded data stream contains code related to the record type, the record value's length, and finally the value itself. In the present example, the type and length are fixed in size (typically 1-4 bytes), and the value field is of variable size. More generally, the scheme for length is known as basic encoding rules-tag-length-value (BER-TLV) (see European Telecommunications Standards Institute Technical Specification ETSI TS 101 220, v8.4.0, clause 7, although note that the tag numbering scheme employed in the presently described example does not follow this scheme). Previous examples for use of TLV include within Transport Layer Security (TLS) and for Subscriber Identification Module (SIM) configuration over the air. However, in the present example use of a predetermined format for a TLV string allows data (such as a measurement or reading from a sensor) to be transmitted at the application layer of a UDP transmission in a highly compact format. This in turn allows for low power consumption at a client device (such as a NB-IoT device), and so preservation of battery level to allow for long operational lifetime.

The described method may be further improved by use of Security Procedures for Battery Efficient Security for Very Low Throughput MTC Devices (BEST) implemented at the application layer. BEST is defined in a 3GPP standard TS 33.163, v. 15.4.0. This 3GPP standard specification defines elements, protocols and procedures that enable battery efficient security for low throughput devices such as machine-to-machine devices (including NB-IoT devices). The BEST service provides a secure channel between a client and a server, optimised for low throughput and high latency devices that are battery constrained. BEST allows for security between the client and either an element in a service provider home network or an element in the enterprise domain. By use of BEST at the application layer, together with the TLV-based protocol described herein, secure and efficient transmission of data between a client and server is improved.

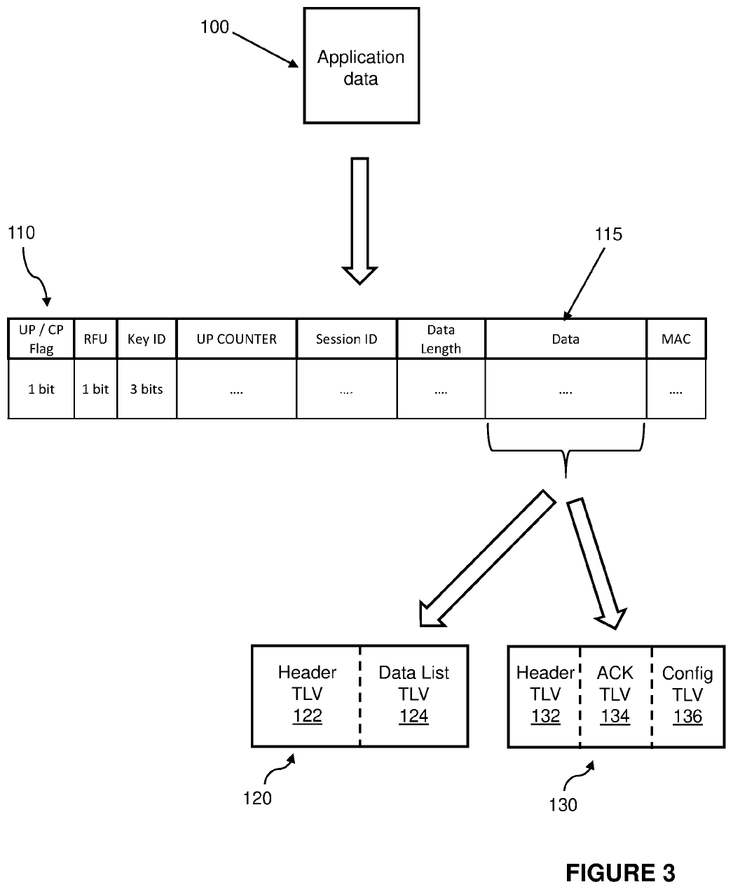

An End to Middle Secured Data Protocol (EMSDP) is used for provision of BEST at the application layer. Messages under EMSDP may include a control plane message and a user plane message. The user plane message 110 may have a structure as shown at FIG. 3. Referring to FIG. 3, there is shown the application layer data 100 (embedded as UDP data at the transport level in FIG. 2), which incorporates the EMSDP user plane message 110. Data for transmission between the client and server (for instance, device measurements or configuration data) is included within the user plane message structure 110 as ‘Data’ field 115. The data in the data filed 115 is TLV encoded, as described above, providing compact data packets.

The TLV encoded data itself has a particular structure. Examples of the TLV-encoded data structure are shown in FIG. 3. A first format 120 for the TLV encoded data applies to data sent from the client (for instance at a NB-IoT device) to the server. For instance, this data may be used to report data measured or recorded at a sensor at an IoT device for storage and processing at a server. In this first format 120, a header TLV 122 is followed by a data list TLV 124. The header TLV 122 may comprise information such as the transport header length, a transaction ID and an optional device ID (see section A.1 below). The data list TLV 124 may comprise information on the data object tag, the data object list length, the data collection event counter, the type of trigger for the data collection, and/or the date & time (see section A.2 below). There may be many data list TLVs 124 in one message.

A second format 130 for the TLV encoded data applies to data sent from the server to the client (for instance, at a NB-IoT device). This data may be used to provide an acknowledgment of an immediately previous data packet at the server, and/or to provide configuration or status data to the client. Where the client is a device such as an actuator, this data may be used to send commands to move or adjust the actuator, for instance. In the second format 130, a header TLV 132 is followed by an acknowledgement TLV 134, and (if present) this is subsequently followed by a configuration TLV 136. The header TLV 132 may comprise information including the number of TLVs being transferred and the transaction identity (ID) (see section C.1 below). The acknowledgement TLV 134 may comprise a suitable tag and a numerical value representative of a delivery message (see section C.2 below). If present, the optional configuration TLV 136 may comprise a suitable tag together with a numerical configuration message (see section C.3 below).

Upon receipt from a client of TLV-encoded data at a server, the data may be stored in the raw format in which it is received at a database of the server. This ensures that the UDP port at the server is quickly returned to a ‘listening’ mode, rather than attending to processing of received data. After storing the raw, received data is later decoded by the server from the TLV format to convert to more easily readable or interpreted results. The interpreted results are stored at a further database at the sever, separately to the raw data, and can be accessed by users over the internet. A web portal may be provided for interaction with the interpreted results by users, and for input of configuration commands to be sent by the server to a client.

FIG. 4 shows the system with the server 14 in more detail. As before, a client 12 is provided. The client 12 is an NB-IoT device comprising a sensor 16a. The client 12 is in communication with a server 14, according to the method described above in which TLV-encoded data is sent via UDP. The server 14 may be a virtual machine.

The server 14 comprises a sensor listener and decoder (SLAD) 22. The SLAD 22 listens to the UDP port at the server 14 to receive messages sent from a client 12. The SLAD 22 stores the raw data as a log file at a database 30 (for instance a MySQL Database) within memory 28 the server.

At a data interpretation module (DIM) 24 the raw data received and stored by the SLAD 22 in the database 30 is converted into interpreted (i.e. easily readable) data. Such interpreted data is suitable for further dissemination to users, and is stored in a further database 32 within the memory 28 at the server.

The interpreted results may available to users via the internet 26. In the example system of FIG. 4, the interpreted data is made accessible to users via a secure web portal 18 (for instance, a Hypertext Preprocessor (PHP) and Javascript based service, allowing third party access to the interpreted data). In addition, the interpreted data is accessible to users via a representational state transfer (REST) application programming interface (API) 20. The web portal 18 or API 20 may allow functions including management of devices, collection and viewing of data, grouping of devices, and the setting of future actions based on measured values at devices.

In the above described method, transmission of TLV-encoded data embedded at the user plane within the BEST service at the application layer allows for use of UDP to send compact but secure messages. The ability to send compact messages is particularly advantageous for NB-IoT devices, which require particularly low power consumption to ensure longevity of a battery at the devices (especially where devices are for use in geographically remote or otherwise inaccessible locations). Moreover, where such NB-IoT devices are sensors or actuators, unauthorised access to data sent and received between devices and the server may result in real-world harm and so require the additional security benefits provided by the described method and system.

Real world uses of NB-IoT devices according to the described method and system include remote sensing devices. Such devices are intended to be low power so that the battery of the device does not need replacing/recharging for long periods of time (perhaps 15 years or more, in which time the battery may naturally degrade in any case). The device may be simple and flexible so that numerous devices may be deployed to gather large quantities of sensor data. Possible use cases for the devices include:
Detecting and predicting landslip (e.g. on cliffs in coastal locations) and monitoring geological conditions. Possible sensors may include environmental and geological sensors, such as:
   Wind
   Rainfall
   Temperature
   Tilt
   Vibration
   Water
   Distance
Agricultural monitoring. Possible sensors may include soil sensors, water sensors botanical sensors, equipment sensors and actuators, such as:
   Trunk size sensors for measuring tree growth including monitoring of carbon capture.
   Motion and location sensors for securing farm equipment.
   Water and chemical fertiliser sensors for monitoring soil quality.
   Water level and water quality sensors for measuring runoff into rivers and other water channels
   Irrigation actuators for opening and closing values within irrigation system.

In real world cases such as those discussed, a predefined format may be employed within the above-described TLV-encoded data structure for communication of variables or commands for particular types of device. The following section includes information on the predefined format for certain TLV-encoded data structures for transmission of measurements and configuration of sensor and actuator devices.

### A. Server-Bound TLV-Encoded Data

This section describes TLV-encoded data sent from the client (for instance, at an NB-IoT device) to the server.

### A.1 Transport Header TLV

This TLV contains the number of TLVs being transferred and the transaction ID. It is used when sending datasets back to the server. In that case this is the first TLV sent. This TLV does not contain the readings as it is a header.

| Description | Value (in Hex) | Comments |
|---|---|---|
| Transport Header | ‘10’ (Tag) | Mandatory Object |
| TLV Tag | | |
| Transport Header | X | 1 byte length |
| Length | | |
| Transaction TLV | ‘XX’ | The number of TLVs contained |
| count | | in the current transaction in |
| | | a 2-byte integer |
| Transaction ID | ‘XXXXXX’ | The ID for the current |
| | | transaction in a 3-byte integer |
| Device ID (opt) | ‘XXXXXXXXXX’ | 10 byte Device ID allocated to |
| | | that specific device. Optional |
| | | as the device ID may be known |
| | | from the transport layer. |

### A.2 Data List TLV

This TLV is a Data list which represents one data gathering event. The data list TLV holds a complete set of readings gathered from a sensor and taken at a specific time in response to a specific event.

| Description | Value (in Hex) | Comments |
|---|---|---|
| Data Object List TLV | ‘20’ (Tag) | Mandatory Object |
| Tag | | |
| Data Object List TLV | XXX | 3 byte BER encoded length (e.g. |
| Length | | 130 bytes is ‘820082’ |
| Data Collection Event | ‘XXXX’ | 4 byte reference generated by |
| Counter | | device |
| Trigger Type | ‘X’ | 1 byte |
| | | 00 - initial start-up |
| | | 01 - data collection only |
| | | 02 - data collection with send |
| | | 03 - interrupt triggered |
| | | 04 - “send now” button pressed |
| | | 05 - data collection with re-send |
| Date/Time | ‘XXXXX’ | Where, 5 bytes are set as |
| | | XXXXX is YYMMDDHHmm |
| | | YY - single byte year in hex |
| | | from 2000 |
| | | MM - single byte month in hex |
| | | DD - single byte day in hex |
| | | HH - single byte hour in hex in |
| | | 24-hour format |
| | | mm - single byte minute in hex |
| | | and where, |
| | | ‘0000000000’ means no date |
| | | known |
| Data Object 1 TLV or | ‘21’ or ‘22’ | |
| Device Constants TLV | | |

. . .

| | |
|---|---|
| Data Object 1 TLV | ‘21’ |

Where:

| | Value | |
|---|---|---|
| Description | (in Hex) | Comments |
| Data Object TLV Tag | ‘21’ | Mandatory Object |
| Data Object TLV | XX | BER encoded length (e.g. 130 |
| Length | | bytes is ‘820104’ |
| Data Type | | 01 - ICCID (from modem) |
| | | 02 - IMSI (from modem) |
| | | 03 - IMEI (from modem) |
| | | . . . |
| | | 10 - Modem SW version |
| | | 11 - MCU SW version |
| | | 12 - UP SW version |
| | | . . . |
| | | 20 - Battery Level |
| | | 21 - Signal Strength (see AT + |
| | | CSQ) |
| | | 22 - Accelerometer X |
| | | 23 - Accelerometer Y |
| | | 24 - Accelerometer Z |
| | | 25 - Accelerometer Xg |
| | | 26 - Accelerometer Yg |
| | | 27 - Accelerometer Zg |
| | | 28 - Accelerometer rawreadings |
| | | . . . |
| | | 30 - ADC 0 |
| | | 31 - ADC 1 |
| | | 32 - ADC 2 |
| | | 33 - ADC 3 |
| | | 34 - ADC 4 |
| | | . . . |
| | | 40 - Digital IO pin 3 |
| | | 41 - Digital IO pin 4 |
| | | 42 - Digital IO pin 5 |
| | | 43 - Digital IO pin 6 |
| | | 44 - Digital IO pin 7 |
| | | 45 - Digital IO pin 8 |
| | | 45 - Digital IO pin 10 |
| | | 46 - Unknown Pin |
| | | . . . |
| | | 50 - onboard GNSS location |
| | | . . . |
| | | 60 - I2C list port 0 |
| | | 61 - I2C list port 1 |
| | | 62 - I2C new device list |
| | | 63 - I2C error device list |
| | | 64 - I2C reading raw |
| | | 65 - I2C reading interpreted |
| | | . . . |
| | | 70 - error - general |
| | | 71 - error - script error |
| | | 72 - error - device missing |
| | | . . . |
| | | . . . |
| | | 80 - interrupt event (watchdog) |
| | | 81 - interrupt event (button press) |
| | | 82 - interrupt event (accelerometer) |
| | | 83 - interrupt event (D0) |
| | | 84 - interrupt event (D1) |
| | | . . . |
| Sensor dB UID | ‘XXXX’ | Identifies a sensor UID in dB to |
| (conditional) | | the server in a 2-byte integer. |
| I2C address | ‘XX’ | Sensor's I2C address in a 1-byte |
| (conditional) | | integer. Only present if data type is |
| | | 64 or 65. |
| Data units | ‘XX’ | Data units as per I2C script in a 1- |
| (conditional) | | byte integer. Only present if data |
| | | type is 64 or 65. |
| | | 01 = ° C. |
| | | 02 = X axis degrees |
| | | 03 = Y axis degrees |
| | | 04 = z axis degrees |
| | | 05 = light lux |
| | | 06 = no units (just text) |
| | | 07 = raw reading from GY-49 |
| | | 08 = raw reading from AHT-20 |
| | | 09 = raw readings from SHT30 |
| | | 10 = NPK sensor 1 - N (Nitrogen) |
| | | in mg of N/Kg of soil |
| | | 11 = NPK sensor 1 - P (Phosphorous) |
| | | in mg of P/Kg of soil |
| | | 12 = NPK sensor 1 - K (Potassium) |
| | | in mg of K/Kg of soil |
| | | 13 = NPK sensor 1 - Temperature |
| | | in ° C. |
| | | 14 = NPK sensor 1 - Humidity as % |
| | | 15 = NPK sensor 1 - Electrical |
| | | Conductivity in micro Siemens/cm |
| | | 16 = NPK sensor 1 - PH |
| | | 17 = RFU |
| | | 18 = NPK sensor 2 - N (Nitrogen) |
| | | in mg of N/Kg of soil |
| | | 19 = NPK sensor 2 - P (Phosphorous) |
| | | in mg of P/Kg of soil |
| | | 1A = NPK sensor 2 - K (Potassium) |
| | | in mg of K/Kg of soil |
| | | 1B = NPK sensor 2 - Temperature |
| | | in ° C. |
| | | 1C = NPK sensor 2 - Humidity as % |
| | | 1D = NPK sensor 2 - Electrical |
| | | Conductivity in micro Siemens/cm |
| | | 1E = NPK sensor 2- PH |
| | | 1F = RFU |
| | | 20 = NPK sensor 3 - N (Nitrogen) |
| | | in mg of N/Kg of soil |
| | | 21 = NPK sensor 3 - P (Phosphorous) |
| | | in mg of P/Kg of soil |
| | | 22 = NPK sensor 3 - K (Potassium) |
| | | in mg of K/Kg of soil |
| | | 23 = NPK sensor 3 - Temperature |
| | | in ° C. |
| | | 24 = NPK sensor 3 - Humidity as % |
| | | 25 = NPK sensor 3 - Electrical |
| | | Conductivity in micro Siemens/cm |
| | | 26 = NPK sensor 3 - PH |
| | | 27 = RFU |
| | | 28 = combined raw NPK sensor |
| | | values |
| Format | ‘XX’ | Indicates the format of the data |
| | | received from the sensor in a 1-byte |
| | | integer |
| | | 01 = logic (high/Low/undefined) |
| | | 02 = I2C address List |
| | | 03 = % value in hex (0 to 100 (dec) |
| | | in whole numbers) |
| | | 04 = Hex Value |
| | | 05 = Dec value |
| | | 06 = VF GPS format |
| | | 07 = ASCI in Hex |
| | | (70 series allocated to mitigate a v1 |
| | | issue with WPX) |
| | | 70 = x axis hex raw |
| | | 71 = y axis hex raw |
| | | 72 = z axis hex raw |
| | | 73 = temperature hex raw |
| | | 74 = Combined accelerometer raw |
| | | 75 = Combined NPK sensor format |
| Data | — | Data in appropriate form (as per |
| | | format) |

Where the ‘GPS format’ (specific to Vodafone) is:

| Item | Length | | Format |
|---|---|---|---|
| latitude | 9 | bytes | DDmm.mmmm |
| “N” or “S” | 1 | byte | “N” or “S” |
| Longitude | 10 | bytes | DDDmm.mmmm |
| “E” or “W” | 1 | byte | “E” or “W” |
| Altitude | Variable bytes | | Floating point height |
| | | | (metres) |
| Comma Seperator | 1 | byte | “,” |
| HDOP | Variable bytes | | Floating point |
| | | | HDOP(metres) |
| Comma Seperator | 1 | byte | “,” |

| | | |
|---|---|---|
| Number Satellites | Variable bytes | integer |

Where ‘Combined accelerometer raw’ is:

| Item | Length | Format |
|---|---|---|
| X-axis raw | 2 bytes | Hex |
| Y-Axis raw | 2 bytes | Hex |
| Z-Axis raw | 2 bytes | Hex |
| Temperature raw | 2 bytes | Hex |

Where ‘Combined NPK raw’ is:

| Item | Length | Format |
|---|---|---|
| Read Status | 2 bytes | Hex |
| Nitrogen raw | 2 bytes | Hex |
| Phosphorous raw | 2 bytes | Hex |
| Potassium raw | 2 bytes | Hex |
| Temperature raw | 2 bytes | Hex |
| Humidity raw | 2 bytes | Hex |
| Conductivity raw | 2 bytes | Hex |
| PH raw | 2 bytes | Hex |

### B. Device Constants TLV

This TLV contains values related to the client (such as an NB IoT device) that are not variable.

| Description | Value (in Hex) | Comments |
|---|---|---|
| Device Constants | ‘22’ (Tag) | Mandatory Object |
| TLV Tag | | |
| Device Constants | ‘3F’ | Fixed length in 1 byte |
| TLV Length | | |
| ICCID | ‘XX XX XX XX | 10-byte char array |
| | XX XX XX XX | |
| | XX XX’ | |
| IMEI | ‘XX XX XX XX | 8-byte char array |
| | XX XX XX XX’ | |
| 1250 SW version | Chars | 24-byte char array as reported by |
| | | AT % VER for ‘NP Package’ |
| SiliconID | chars | 16 bytes of hex |
| UP SW version | ‘XX XX XX XX | 5-byte char array |
| | XX’ | |

### C. Device Bound TLV-Encoded Data

This section describes TLV-encoded data sent from the server to the client (for instance, at an NB-IoT device).

### C.1 Transport TLV

This TLV contains the number of TLVs being transferred and the transaction ID. The Transport TLV will always be the first TLV in the response message.

| | Value | |
|---|---|---|
| Description | (in Hex) | Comments |
| Transport Object TLV | ‘80’ (Tag) | Mandatory Object |
| Tag | | |
| Transport Object | XX | BER encoded length (e.g. 130 |
| Length | | bytes is ‘820104’ |
| Transaction TLV | ‘XX’ | The number of TLVs contained |
| count | | in the current transaction in a |
| | | 2-byte integer |
| Transaction ID | ‘XXXXXX’ | The ID for the current transaction |
| | | in a 3-byte integer |

### C.2 ACK/NACK TLV

Only on ACK/NACK TLV will be included per device bound message. It will be the first TLV immediately after the Transport TLV.

| Description | Value (in Hex) | Comments |
|---|---|---|
| ACK/NACK TLV Tag | ‘90’ (Tag) | Mandatory Object |
| ACK/NACK TLV | ‘01’ | |
| Length | | |
| ACK/NACK message | ‘XX’ | 20 - OK |
| | | . . . |
| | | 40 - Bad request |
| | | 41 - Unauthorised |
| | | 43 - Forbidden |
| | | 44 - Not found |
| | | 45 - Method not allowed |
| | | 46 - Not acceptable |
| | | 48 - Time out |
| | | 49 - Too many requests |
| | | 50 - Internal server error |
| | | 53 - Service unavailable |
| | | 59 - Authentication required |

### C.3 Configuration TLV (Optional)

| Description | Value (in Hex) | Comments |
|---|---|---|
| Configuration TLV Tag | ‘A0’ | Mandatory Object |
| Configuration TLV | XX | BER encoded length (e.g. |
| Length | | 130 bytes is ‘820104’ |
| Load I2C Script TLV (Opt) | ‘Ax’ TLVs | |

Where ‘Ax TLVs’ are:

| Description | Value (in Hex) | Comments |
|---|---|---|
| UP duty cycle TLV Tag | ‘A1’ | Mandatory Object |
| UP duty cycle TLV Length | ‘07’ | Single byte length |
| Sleep period | ‘XXXXXXXX’ | In seconds |
| Transmit cycle | ‘XX’ | In number of readings that trigger a |
| | | ‘send’ |
| Location cycle | ‘XXXX’ | In number of readings that trigger a |
| | | location collection |
| Repeating Readings list | ‘A2’ | Mandatory Object |
| TLV Tag | | |
| Load I2C Script TLV Length | XX | Single byte length |
| Repeating reading list | ‘XX . . . XX’ | File content for |
| content | | MEASUREMENTS_REPEATING |
| | | file |
| One Off Readings list TLV | ‘A3’ | Mandatory Object |
| Tag | | |
| Load I2C Script TLV Length | XX | Single byte length |
| One Off reading list content | ‘XX . . . XX’ | File content for |
| | | MEASUREMENTS_ONE_OFF file |
| Load I2C Script TLV Tag | ‘A4’ | Mandatory Object |
| Load I2C Script TLV Length | XX | Single byte length |
| Slot to be written to | ‘XX’ | Where ‘XX’ is less than the number |
| | | of I2C scripting slots for that device |
| File Contents | | File Contents to be written |
| Set LED TLV Tag | ‘A5’ | Mandatory Object |
| Load I2C Script TLV Length | XXXXXX | Single byte length |
| Slot to be written to | ‘XX’ | LED colour |
| | | 0 = Red |
| | | 1 = Green |
| | | 2 = Blue |
| | | 3 = Yellow |
| | | 4 = Purple |
| | | 5 = Cyan |
| | | 6 = White |
| File Contents | ‘XX’ | Duration of LED in units of 100 ms |
| | | ‘FF’ = always on |

A number of combinations of the various described embodiments could be envisaged by the skilled person. All of the features disclosed herein may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” means “one or more”. Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

1. A method for communication of data between a client and a server over a telecommunication network, comprising:
encoding the data using tag-length-value (TLV) encoding scheme; and
sending the encoded data via User Datagram Protocol (UDP).

2. The method of claim 1, wherein the client is a narrow band Internet of Things (NB-IoT) device, and/or the client communicates with the telecommunications network using NB-IoT technology.

3. The method of claim 2, wherein the NB-IoT device comprises one or more sensors and/or actuators.

4. The method of claim 1, wherein sending the encoded data via UDP comprises sending the encoded data in the user plane in a data field of a user plane message.

5. The method of claim 1, wherein the sending uses Security Procedures for Battery Efficient Security for Very Low Throughput MTC Devices (BEST).

6. The method of claim 3, wherein the data to be sent from the client to the server comprises a measurement from the sensor.

7. The method of claim 1, wherein the data to be sent from the server to the client comprises configuration or control data.

8. The method of claim 1, wherein the data to be sent from the server to the client comprises an acknowledgment.

9. A client for communication of data to and/or from a server over a telecommunication network, configured to:
send or receive, via User Datagram Protocol (UDP), data encoded using tag-length-value (TLV) encoding scheme.

10. The client of claim 9, further configured to:
encode data using the TLV encoding scheme; and/or
decode data encoded using the TLV encoding scheme.

11. The client of claim 9, wherein the client is a narrow band Internet of Things (NB-IoT) device, and/or the client communicates with the telecommunications network using NB-IoT technology.

12. A server for communication of data from and/or to a client over a telecommunication network, configured to:
send or receive, via User Datagram Protocol (UDP), data encoded using tag-length-value (TLV) encoding scheme.

13. The server of claim 12, further configured to:
decode received data encoded using the TLV encoding scheme; and
store the decoded data.

14. The server of claim 12, further configured to:
encode data using the TLV encoding scheme, the encoded data for sending from the server via UDP.

15. (canceled)
